(19) United States
(12) Patent Application Publication
(10) Pub. No.: US 2026/0341999 A1
(43) Pub. Date: Oct. 29, 2026

(54) SHIELD CONNECTOR AND METHOD FOR ASSEMBLING SHIELD CONNECTOR

(71) Applicant: JAPAN AVIATION ELECTRONICS INDUSTRY, LIMITED, Tokyo (JP)

(72) Inventors: Takamitsu NAKAJIMA, Tokyo (JP); Tomoyuki HIRANO, Tokyo (JP); Akinori KIMURA, Tokyo (JP)

(73) Assignee: JAPAN AVIATION ELECTRONICS INDUSTRY, LIMITED, Tokyo (JP)

(21) Appl. No.: 19/570,476

(22) Filed: Mar. 18, 2026

(30) Foreign Application Priority Data
Apr. 25, 2025 (JP) 2025-072848

(51) Int. Cl. H01R 13/504; H01R 13/02; H01R 13/424; H01R 13/627; H01R 13/6581; H01R 24/20; H01R 43/048

(52) U.S. Cl. CPC H01R 13/504; H01R 13/025; H01R 13/424; H01R 13/6272; H01R 13/6581; H01R 24/20; H01R 43/048

(57) ABSTRACT

A first ground shell includes: a first crimp portion having a first circumferential diameter after swaging and covering an outer periphery of an insulation portion of a wire exposed; a second crimp portion having a second circumferential diameter, after the swaging and covering an outer periphery of a shield portion of the wire; a third crimp portion coupling the first and the second crimp portion to each other; and a projection portion engaging with an end surface of a sleeve portion of the wire to restrict further movement of the sleeve portion, a first and a second end portion being abutted on each other, the third crimp portion being abutted on a predetermined region of a folded portion of the wire and a tip of the folded portion and the sleeve portion accordingly moving in a direction away from an end surface of a sheath portion of the wire.

### TECHNICAL FIELD

The present disclosure relates to a connection reliability technology for shield connectors.

### BACKGROUND ART

As a prior art for a shield connector, for example, Japanese Patent Application Laid Open No. 2024-92558 (hereinafter, referred to as "Patent Literature 1") is disclosed. FIGS. 1 and 2 illustrate a shield connector of the prior art. A female connector 2A includes a shield module 4A, and an outer housing 40A which accommodates and holds the shield module 4A. The shield module 4A includes an inner terminal 10A, an inner housing 20A, and an outer terminal 30A.

The inner terminal 10A includes connection portions 11A and clamping pieces 12A. The connection portion 11A has a box shape, is arranged at a front-end portion of the inner terminal 10A and is electrically connected with a mating terminal. The clamping piece 12A crimps a conductor core wire 51A at a rear side of the connection portion 11A. The inner terminal 10A is a female terminal into which an inner terminal of a male connector, which is not shown, is to be inserted into a hollow portion of the connection portion 11A.

The inner housing 20A is made of insulating synthetic resin having a predetermined dielectric constant and includes a main body portion 21A having a substantially rectangular cylindrical shape. The main body portion 21A has a pair of terminal accommodation chambers 22A which are formed in a manner to penetrate through the main body portion 21A in the front-rear direction and accommodate and hold the inner terminal 10A.

The outer terminal 30A includes an accommodation portion 31A and a crimp portion 32A in an integral manner. The accommodation portion 31A has a substantially rectangular cylindrical shape and is arranged at the front-end portion of the outer terminal 30A so as to accommodate and hold the inner housing 20A. The crimp portion 32A is composed of a pair of clamping pieces 33A and 34A which are arranged in the front-rear direction at the rear of the accommodation portion 31A. The clamping piece 33A has a function for crimping a shield body 53A, and the clamping piece 34A has a function for crimping an insulation sheath 54A of a shield wire 50A.

The outer housing 40A is made of insulating synthetic resin and includes a main body portion 41A and a hood portion 42A in an integral manner. The main body portion 41A has a substantially rectangular cylindrical shape. The hood portion 42A is arranged at the front of the main body portion 41A, has a larger diameter than the main body portion 41A, and has a substantially rectangular cylindrical shape. The hood portion 42A is to be inserted into and fitted to an outer housing of a male connector, which is not shown.

In a hollow portion of the main body portion 41A, a locking lance (not shown) having an elastically deformable cantilever-shape is provided. The locking lance has a function for holding the outer terminal 30A (that is, the shield module 4A) which is accommodated in the outer housing 40A in a manner in which a projection portion 35A of the outer terminal 30A is locked.

On an upper end portion of the main body portion 41A, a locking arm 44A having an elastically deformable cantilever-shape is provided. In a substantially central region in the front-rear direction of the locking arm 44A, a locking projection 45A projecting upward is provided.

### SUMMARY OF THE INVENTION

However, shield connectors having configurations as the above-described configuration of Patent Literature 1 have had a problem in that positions of internal terminals (inner terminals) vary within manufacturing tolerances during a harness production process, resulting in unstable performance of the shield connectors.

An object of the present disclosure is to provide a shield connector in which variation in positions of internal terminals can be suppressed.

To solve the above-described problem, a shield connector according to the present embodiment includes: a wire including a core wire; and a first ground shell fixed at an end portion of the wire by swaging a first end portion and a second end portion, which are open end portions, in a mutually abutted manner. The wire includes: an insulation portion which covers an outer periphery of the core wire; a sheath portion which covers an outer periphery of the insulation portion in a manner to expose one end portion of the insulation portion for a predetermined length; a sleeve portion which is made of metal and covers an outer periphery of the sheath portion for a predetermined length in a longitudinal direction of the shield connector; and a shield portion. The shield portion includes: a main body portion which covers the outer periphery of the insulation portion from an inner periphery side of the sheath portion; and a folded portion which covers an end surface on one end portion side of each of the sheath portion and the sleeve portion and covers an outer periphery of the sleeve portion for a predetermined length in the longitudinal direction of the shield connector. The first ground shell includes a first crimp portion, a second crimp portion, a third crimp portion, and a projection portion. The first crimp portion is a first region extending from a part of the first end portion to a part of the second end portion, and is to have a ring shape with a first circumferential diameter after the swaging and cover the outer periphery of the insulation portion which is exposed. The second crimp portion is a second region extending from another part of the first end portion to another part of the second end portion, and is to have a ring shape with a second circumferential diameter, which is longer than the first circumferential diameter, after the swaging and cover an outer periphery of the shield portion. The third crimp portion couples the first crimp portion and the second crimp portion to each other from the first end portion to the second end portion. The projection portion engages with the end surface of the sleeve portion so as to restrict further movement of the sleeve portion, when the first end portion and the second end portion are swaged in a mutually abutted manner and when the third crimp portion is abutted on a predetermined region of the folded portion and a tip of the folded portion and the sleeve portion accordingly move in a direction away from the end surface of the sheath portion.

### EFFECTS OF THE INVENTION

According to the present embodiment, variation in positions of internal terminals can be suppressed.

### BRIEF DESCRIPTION OF THE DRAWINGS

FIG. 1 illustrates a shield connector of a prior art.

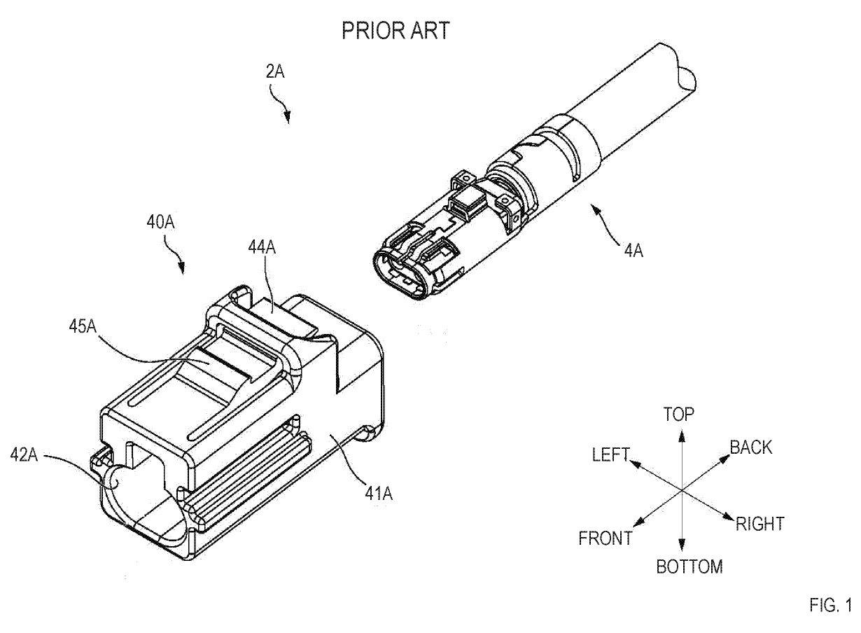

FIG. 2 illustrates the shield connector of the prior art.

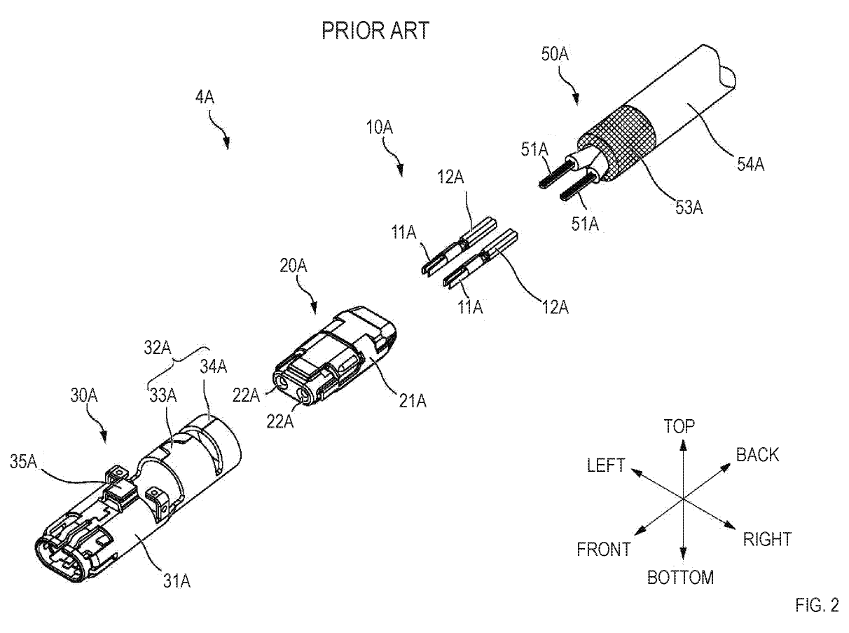

FIG. 3 is a perspective view illustrating an example of a shield connector according to the present embodiment.

FIG. 4 is an exploded perspective view of the shield connector according to the present embodiment.

FIG. 5 is an exploded perspective view of a shield module according to the present embodiment.

FIG. 6 is a diagram illustrating an enlarged portion of a B-B section in FIG. 4.

FIG. 7 is a perspective view illustrating a state of a sleeve portion before swaging as viewed from below.

FIG. 8 is a perspective view illustrating a state of a signal contact before swaging as viewed from below.

FIG. 9 is a perspective view illustrating a state of a first ground shell before swaging as viewed from below.

FIG. 10 is a perspective view illustrating a state of the first ground shell in a first shield sub-module before swaging as viewed from below.

FIG. 11 is a perspective view illustrating a second shield sub-module as viewed from above.

FIG. 12 is a perspective view illustrating a state of the first ground shell in the shield module before swaging as viewed from below.

FIG. 13 is a front view of FIG. 12.

FIG. 14 is a diagram illustrating an enlarged portion of an E-E section in FIG. 13.

FIG. 15 is a perspective view illustrating a state of the first ground shell in the shield module after swaging as viewed from below.

FIG. 16 is a front view of FIG. 15.

FIG. 17 is a diagram illustrating an enlarged portion of an F-F section in FIG. 16.

### DETAILED DESCRIPTION OF THE EMBODIMENTS

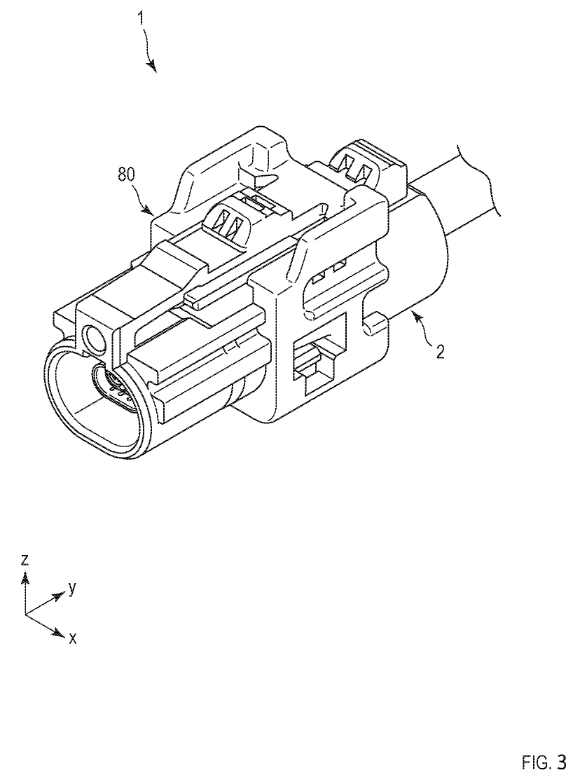

An embodiment according to the present disclosure will be described below with reference to the accompanying drawings. In the following description, components having the mutually-same functions will be provided with the mutually-same reference characters and duplicate description thereof will be omitted. Unless otherwise specified, the present disclosure will describe the +x direction as "right", the -x direction as "left", the +y direction as "rear", the -y direction as "front", the +z direction as "upper", and the -z direction as "lower" from the perspective shown in FIG. 3.

### Shield Connector

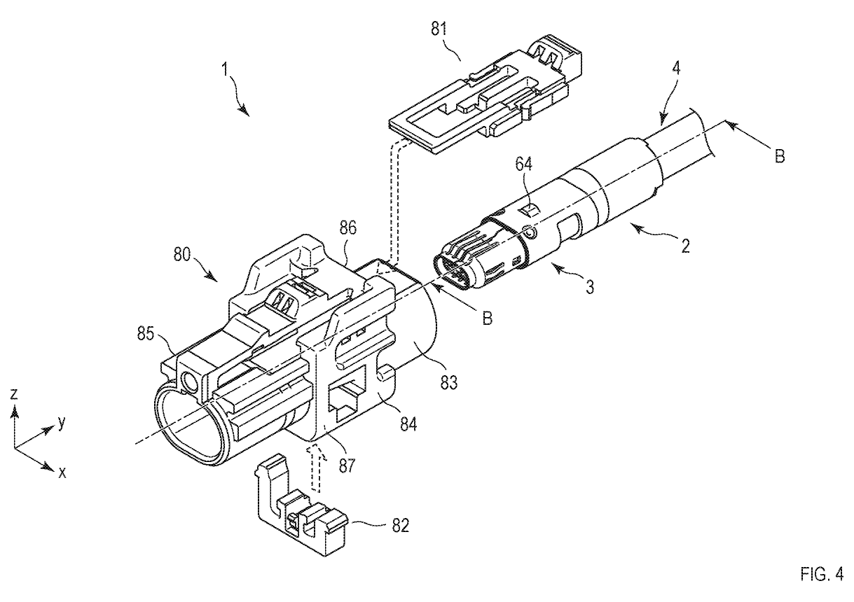

FIG. 3 is a perspective view illustrating an example of a shield connector according to the present embodiment. FIG. 4 is an exploded perspective view of the shield connector according to the present embodiment. A shield connector 1 according to the present embodiment is a female connector and is a connector which can be fitted to and electrically connected with a male connector which is a mating connector and is not shown. The shield connector 1 according to the present embodiment includes a second housing 80 and a shield module 2.

### Second Housing 80

The second housing 80 is made of an insulating material such as synthetic resin and is an external housing in the shield connector 1. The second housing 80 includes an accommodation portion 83, a first box-shaped portion 84, and a second box-shaped portion 85. The accommodation portion 83 has a substantially elliptical cylindrical shape and has a through hole. The first box-shaped portion 84 has a substantially cubic shape and is located around the central portion in a longitudinal direction (y-axis direction) of the accommodation portion 83. The second box-shaped portion 85 has a substantially rectangular parallelepiped shape and is located around an upper front side of the accommodation portion 83. The shield module 2 is inserted from the rear of the accommodation portion 83. A lance (not shown) is provided in the accommodation portion 83 so as to fit and hold the shield module 2 at a predetermined position. The lance abuts on a positioning protrusion portion 64, which is included in a first shield sub-module 3 of the shield module 2 inserted into the second housing 80, thereby positioning the shield module 2. The second housing 80 accommodates and holds the shield module 2 in the second housing 80. The second housing 80 is fitted to the mating connector by inserting the front side of the accommodation portion 83 and the second box-shaped portion 85 into the mating connector.

The second housing 80 includes a CPA 81 and a retainer 82. The CPA 81 and the retainer 82 has insulating properties and are made of synthetic resin in this example. The CPA 81 is inserted into an opening portion 86 formed at the upper rear portion of the first box-shaped portion 84, and functions as part of a locking mechanism which locks fitting when the shield connector 1 is fitted to the mating connector. The retainer 82 is inserted from an opening portion 87 formed at the bottom surface side (-z direction side) of the accommodation portion 83 and the first box-shaped portion 84, and functions as part of a locking mechanism which holds the position of the shield module 2.

### Shield Module 2

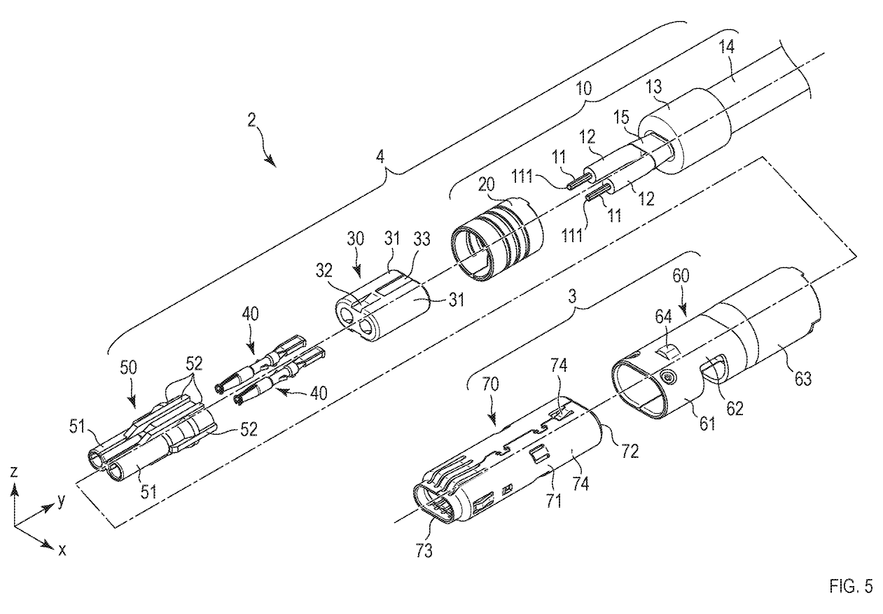

FIG. 5 is an exploded perspective view of the shield module according to the present embodiment. The shield module 2 includes a wire 10, a holder 30, signal contacts 40, a first housing 50, a first ground shell 60, and a second ground shell 70. In the present disclosure, the first ground shell 60 in which the second ground shell 70 is accommodated will also be referred to as the "first shield sub-module 3". The first shield sub-module 3 serves as an external terminal in the shield module 2. The first shield sub-module 3 has conductivity and accommodates and holds part of a second shield sub-module 4. The first shield sub-module 3 is shield-connected to a shield portion 13 of the wire 10. An assembly composed of the wire 10, the holder 30, the signal contacts 40, and the first housing 50 will also be referred to as the "second shield sub-module 4". The second shield sub-module 4 serves as an internal terminal in the shield module 2.

### Wire 10

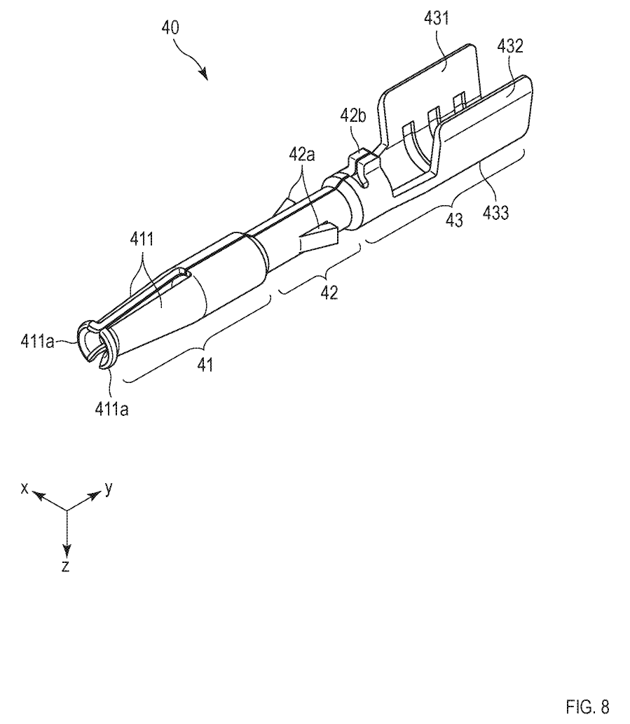

The wire 10 includes conductive core wires 11, insulation portions 12, an aluminum foil 15, the shield portion 13, a sheath portion 14, and a sleeve portion 20. The wire 10 is electrically connected with the signal contacts 40 in a manner in which the core wires 11 are crimped to respective clamping portions 43 (see FIG. 8) of the signal contacts 40. Here, the sleeve portion 20 is combined with the wire 10 as described later, but it is also possible to prepare the wire 10 which does not include the sleeve portion 20 and attach the sleeve portion 20 to the wire 10 during assembly.

The insulation portion 12 is an insulating member covering an outer periphery of the core wire 11. The insulation portions 12 in this example cover respective outer peripheries of the pair of core wires 11 in a manner to expose one ends (end portions 111) of the core wire 11. The aluminum foil 15 covers outer peripheries of the pair of insulation portions 12 with the end portions 111 exposed. As in this example, the aluminum foil 15 may cover the outer peripheries in a manner to expose one end portions (end portions closer to the end portions 111) of the insulation portions 12 for a predetermined length as well as the core wires 11. The shield portion 13 covers the outer peripheries of the insulation portions 12 in a manner to expose the end portions 111 with the aluminum foil 15 interposed therebetween. The shield portion 13 in this example is configured as a braided wire. As in this example, the shield portion 13 may cover the outer peripheries in a manner to expose one end portions, closer to the end portions 111, of the insulation portions 12 for a predetermined length as well as the core wires 11. The sheath portion 14 covers the shield portion 13 with the end portions 111 exposed. As in this example, the sheath portion 14 may cover the outer peripheries in a manner to expose one end portions, closer to the end portions 111, of the insulation portions 12 for a predetermined length as well as the core wires 11.

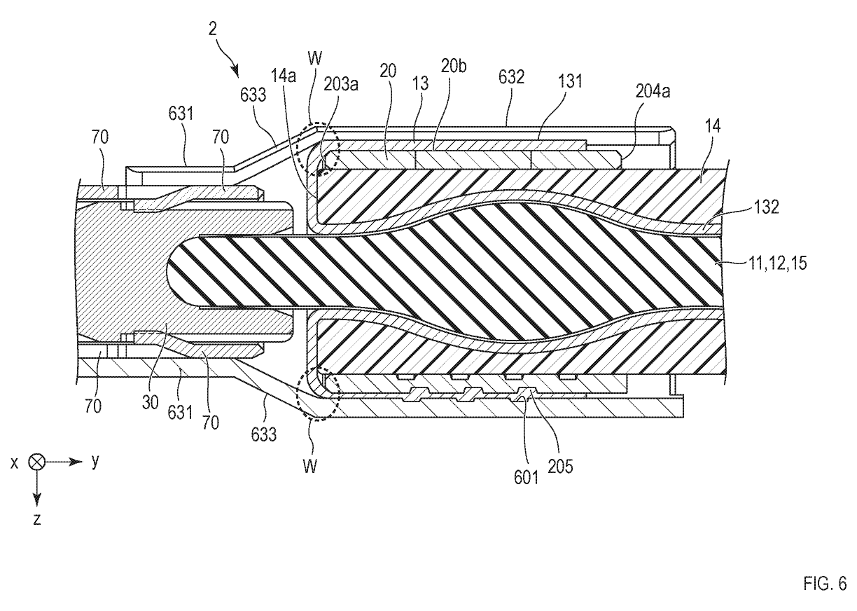

FIG. 6 is a diagram illustrating an enlarged portion of a B-B section in FIG. 4. In FIG. 6, the core wire 11, the insulation portion 12, and the aluminum foil 15 are simplified and shown as a single member. A folded portion 131 on one end side (the end portion 111 side) of the core wire 11 in the shield portion 13 is positioned in a manner to cover an end surface 14a on the front side of the sheath portion 14, cover an end surface 203a on the front side and an outer surface 20b of the sleeve portion 20, and face an opposite side from the end portion 111 side, namely, face the +y direction which is the rear side shown in FIG. 6. That is, the shield portion 13 includes a main body portion 132 which covers the outer periphery of the insulation portion 12 from the inner periphery side of the sheath portion 14, and the folded portion 131 which covers each of the end surface 14a of the sheath portion 14 and the end surface 203a on one end portion side of the sleeve portion 20 and covers the outer periphery (the outer surface 20b) of the sleeve portion 20 for a predetermined length in the longitudinal direction (y-axis direction) of the shield connector 1.

### Sleeve Portion 20

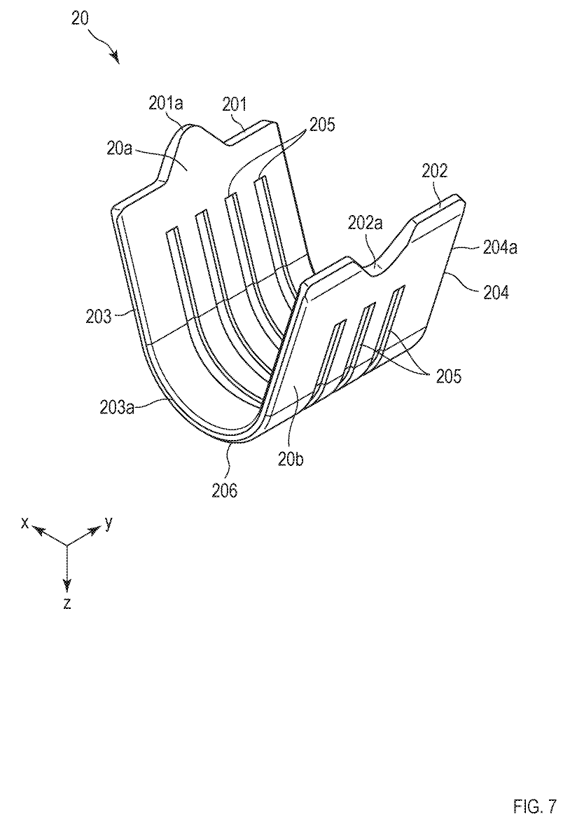

FIG. 7 is a perspective view illustrating a state of the sleeve portion before swaging as viewed from below. The sleeve portion 20 reinforces the periphery of the core wires 11. The sleeve portion 20 is a metal member which covers the outer periphery of the sheath portion 14 for a predetermined length in the longitudinal direction (y-axis direction) of the shield connector 1. The sleeve portion 20 in this example is a stainless steel member which covers the periphery of the sheath portion 14 with the end portions 111 exposed, and has a substantially cylindrical shape. The sleeve portion 20 in this example is formed by molding a substantially-rectangular thin flat plate, and has end portions 201 and 202 which are end portions in the longitudinal direction (x-axis direction) of the rectangular shape and end portions 203 and 204 which are end portions in the short-hand direction (y-axis direction). The sleeve portion 20 has a plurality of concave grooves 205 arranged in parallel, thereby enhancing frictional force. The grooves 205 on both surfaces (inner surface 20a and outer surface 20b) of the rectangular shape form a staggered pattern. The grooves 205 formed on the inner surface 20a enhances the frictional force against the sheath portion 14. The grooves 205 formed on the outer surface 20b enhances the frictional force against the shield portion 13. The grooves 205 contribute to weight reduction while ensuring rigidity. The sleeve portion 20 before assembly is formed by press working such that the central portion of the sleeve portion 20 in the longitudinal direction (x-axis direction) is shaped to be semi-cylindrical, enabling a bottom portion 206 to surround part of the outer periphery of the sheath portion 14 in advance. In the sleeve portion 20, a protrusion portion 201a is formed in the central portion of the end surface of the end portion 201, and a cutout portion 202a is formed in the central portion of the end surface of the end portion 202. By allowing the end surface of the end portion 201 and the end surface of the end portion 202 to face in mutually abutting manner, the protrusion portion 201a and the cutout portion 202a engage with each other to form a ring shape, reinforcing the sheath portion 14 positioned around the core wires 11. In other words, the sleeve portion 20 has the end portion 201 which is one end portion and the end portion 202 which is an end portion opposite to the end portion 201 and allows the end surface of the end portion 201 and the end surface of the end portion 202 to face in mutually abutting manner, thereby swaging the sheath portion 14 in a circumferential direction. Here, the sleeve portion 20 at the stage being attached to the electric wire 10 is swaged enough to reinforce the sheath portion 14 but has not yet reached a state in which a relative positional relationship between the sleeve portion 20 and the sheath portion 14 is fixed through crimping the sheath portion 14 by the sleeve portion 20.

### Holder 30

The holder 30 (FIG. 5) covers the end portions of the insulation portions 12 on the end portions 111 sides and positions the core wires 11 for insertion into the respective signal contacts 40. The holder 30 is a member formed by integrating a pair of substantially-cylindrical accommodation portions 31 in parallel, each having a through hole through which the core wire 11 and the insulation portion 12 can be inserted. On each central portion of an upper surface and a lower surface of the holder 30, a groove 32 and a groove 33 are formed at a front portion and a rear portion, respectively. The holder 30 in this example is made of die-cast material. However, the holder 30 may be made of synthetic resin, or it may be made of synthetic resin with metal plating applied thereto.

### Signal Contact 40

FIG. 8 is a perspective view illustrating a state of the signal contact before swaging as viewed from below. The signal contact 40 has conductivity and is an internal terminal of the shield module 2. In the signal contact 40, the core wires 11 are inserted into the rear of the respective signal contacts 40 and swaged and thus the core wires 11 are crimped by the signal contacts 40. The signal contacts 40 after swaging have elongated-cylindrical outer shapes with through holes and accept direct insertion of terminals of the mating connector, thereby establishing conduction between the signal contacts 40 and the terminals of the mating connector. Accordingly, the conduction between the shield connector 1 and the mating connector is established. The signal contacts 40 in this example are made of a copper alloy.

The signal contact 40 is a conductive member composed of a connection portion 41 on the front side, a clamping portion 43 on the rear side, and a coupling portion 42 which couples the connection portion 41 and the clamping portion 43. The connection portion 41 has a substantially cylindrical shape, and the cylindrical shape gradually tapers (becomes smaller) from the vicinity of the center of the connection portion 41 toward the front. The connection portion 41 is split from the center of the connection portion 41 toward the tip end to have a tip split shape, forming a pair of receiving portions 411 which are arranged in parallel and have semi-cylindrical shapes whose inner surfaces face each other. At the tip ends of the respective receiving portions 411, opening ends 411a are formed in a direction expanding the cylindrical shape, and thus configured to facilitate positioning and insertion of the terminals of the mating connector. In the coupling portion 42 in this example, a pair of protrusion portions 42a are formed on the outer periphery of the central portion in the width direction (x-axis direction) of the coupling portion 42. The clamping portion 43 has a substantially cylindrical shape at the front side and has a substantially U-shape at the rear side before swaging. As illustrated in FIG. 8, in the clamping portion 43, a bottom portion (bottom portion 433) in the U-shaped portion in the clamping portion 43 and an upper side of the substantially cylindrical shape are coupled to each other. In other words, the rear side portion of the clamping portion 43 has an end portion 431 which is one end portion and an end portion 432 which is the other end portion, and a portion (bottom portion 433) coupling the end portion 431 to the end portion 432 has a semi-cylindrical shape. The signal contact 40 in this example is formed from a thin flat plate. In the clamping portion 43 before insertion of the core wire 11, as illustrated in FIG. 8, both of the end portion 431 and the end portion 432 face one side (-z direction side), forming a U-shape with one side (bottom portion 433) closed and the other (end portions 431, 432) open. After the core wire 11 is inserted, the end portion 431 and the end portion 432 are deformed in a mutually abutted manner and the wire 10 and the signal contact 40 are swaged for positioning and reinforcement of the core wire 11. A protrusion portion 42b is formed on the upper front portion of the clamping portion 43. The protrusion portions 42a are locked by a locking mechanism, which is provided on an inner surface of the first housing 50 and is not shown, when the signal contact 40 is inserted and accommodated in the first housing 50. At this time, the protrusion portion 42b is abutted on a step portion (not shown) formed in the first housing 50. This restricts further insertion of the signal contact 40 into the first housing 50. The protrusion portions 42a and the protrusion portion 42b maintain accommodation of the signal contact 40 in the first housing 50.

### First Housing 50

The first housing 50 (FIG. 5) is made of an insulating material such as synthetic resin and is an internal housing in the shield connector 1. The first housing 50 insulates the signal contacts 40 from the second ground shell 70. The first housing 50 has a shape obtained by integrating a pair of accommodation portions 51 which have a substantially cylindrical shape and are arranged in parallel. The accommodation portion 51 is an elongated cylindrical insulating member which has a through hole into which the signal contact 40 is inserted. The first housing 50 accommodates and insulates the signal contacts 40 and also serves as the tip end portion of the second shield sub-module 4 and thus functions as an insertion portion into the first shield sub-module 3. On the rear side portion of the first housing 50, rib-shaped slide portions 52 are provided on the upper side and lateral sides of the cylindrical shape to facilitate insertion and positioning. The first housing 50 is inserted from the rear of the first ground shell 60 and accommodated in the second ground shell 70.

### First Ground Shell 60

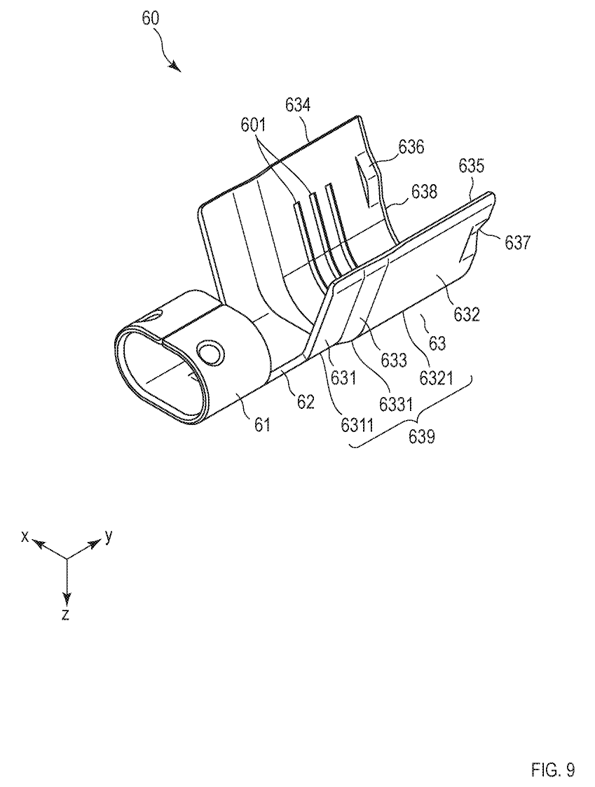

FIG. 9 is a perspective view illustrating a state of the first ground shell before swaging as viewed from below. The first ground shell 60 accommodates and holds the second ground shell 70 and the holder 30. The first ground shell 60 is shield-connected to the shield portion 13. The first ground shell 60 has a substantially cylindrical shape when the shield module 2 is assembled. The first ground shell 60 is made of metal such as copper and thus is a conductive ground shell. The first ground shell 60 includes an accommodation portion 61 on the front side, a crimp portion 63 on the rear side, and a coupling portion 62 which is a plate-shaped portion coupling part of a rear end of the accommodation portion 61 and part of a front end of the crimp portion 63 to each other. The first ground shell 60 further includes projection portions 636 and 637. Here, the projection portions 636 and 637 in this example are formed to be integrated with the crimp portion 63 as part of the crimp portion 63. In other words, the projection portions 636 and 637 are not necessarily formed as part of the crimp portion 63. For example, the projection portions 636 and 637 may be formed in a manner to be coupled from an end portion of the crimp portion 63. The first ground shell 60 in this example is formed from a flat plate having a substantially rectangular shape, in which a portion is cut out to form the coupling portion 62, and accordingly, the first ground shell 60 is formed from the flat plate having respective rectangular portions for the accommodation portion 61, the coupling portion 62, and the crimp portion 63. The projection portions 636 and 637 in this example are formed by applying press working to portions of the crimp portion 63.

The accommodation portion 61 has a substantially elliptical cylindrical shape. The accommodation portion 61 is formed into a ring shape by abutting and crimping both end portions in the longitudinal direction (x-axis direction) of the rectangular flat plate portion of the accommodation portion 61 before shaping so that a through hole is formed between the front and rear sides of the accommodation portion 61. The first ground shell 60 has the positioning protrusion portion 64 (FIG. 4) protruding from the upper side (+z direction side) of the front side (accommodation portion 61 side).

The crimp portion 63 has a first crimp portion 631, a second crimp portion 632, a third crimp portion 633, and the projection portions 636 and 637. In the present disclosure, the projection portion 636 and the projection portion 637 are also referred to as the "first projection portion" and the "second projection portion", respectively. The first crimp portion631, the second crimp portion 632, and the third crimp portion 633 have a substantially U-shape before swaging and at both ends facing the -z direction, a first end portion 634 is formed on one side, and a second end portion 635 is formed on the opposite side from the first end portion 634. Accordingly, a bottom portion 639 composed of bottom portions 6311, 6321, and 6331 is formed on the upper side (+z direction side). The first ground shell 60 in this example has three concave grooves 601 in parallel at a position corresponding to the inner surface of the second crimp portion 632 after swaging, thereby enhancing the frictional force against the shield portion 13. The grooves 601 continue to contribute to weight reduction while ensuring rigidity.

The first crimp portion 631 is positioned on the front side of the crimp portion 63, and after the crimp portion 63 is swaged, the first crimp portion 631 covers the insulation portions 12 with the second ground shell 70, the holder 30, and the aluminum foil 15 interposed therebetween. The first crimp portion 631 is a region (hereinafter also referred to as the "first region") extending from a part of the first end portion 634 to a part of the second end portion 635 and is to have a ring shape with a first circumferential diameter R1 after swaging and cover the outer periphery of the insulation portions 12 which is exposed.

The second crimp portion 632 is positioned on the rear side of the crimp portion 63, and after the crimp portion 63 is swaged, the second crimp portion 632 covers the outer periphery of the shield portion 13. The second crimp portion 632 is a region (hereinafter also referred to as the "second region") extending from another part of the first end portion 634 to another part of the second end portion 635 and is to have a ring shape with a second circumferential diameter R2 longer than the first circumferential diameter R1 after swaging and cover the outer periphery of the shield portion 13.

The third crimp portion 633 couples the first crimp portion 631 and the second crimp portion 632 to each other from the first end portion 634 to the second end portion 635. The third crimp portion 633 couples the first crimp portion 631 and the second crimp portion 632 on the upper side (+z direction side).

The projection portions 636 and 637 in this example are formed on positions in the second crimp portion 632 which are to be on an inner side of the ring shape after swaging. When the first end portion 634 and the second end portion 635 are swaged in a mutually abutted manner and when the third crimp portion 633 is abutted on a predetermined region (region W in FIG. 6) of the folded portion 131 and the tip of the folded portion 131 and the sleeve portion 20 accordingly move in a direction away from the end surface 14a of the sheath portion 14 (+y direction), the projection portions 636 and 637 engage with an end surface 204a of the sleeve portion 20, thereby restricting further movement of the sleeve portion 20. The projection portions 636 and 637 in this example are formed in the vicinity of an end portion 638 in the circumferential direction in the second crimp portion 632. The first projection portion 636 is formed in the vicinity of the first end portion 634, and the second projection portion 637 is formed in the vicinity of the second end portion 635.

### Second Ground Shell 70

The second ground shell 70 (FIG. 5) has conductivity and is an external terminal of the shield module 2. The second ground shell 70 accommodates and holds the second shield sub-module 4. The second ground shell 70 is a ground shell which is made of, for example, copper and has an accommodation portion 71 having a substantially elliptical cylindrical shape. The second ground shell 70 has a through hole in which the second shield sub-module 4 can be inserted. The second ground shell 70 has an opening portion 72 which is positioned on the rear end side and through which the second shield sub-module 4 is to be inserted, and an opening portion 73 which is positioned on the front-end side and is an opening portion slightly smaller than the opening portion 72. On each rear end side of an upper surface and a lower surface of the accommodation portion 71, an engagement piece 74 for engaging with the holder 30 is provided. The engagement piece 74 passes through the groove 32 and engages with the groove 33 when the holder 30 is inserted, thereby preventing the holder 30 from unexpectedly coming off from the second ground shell 70.

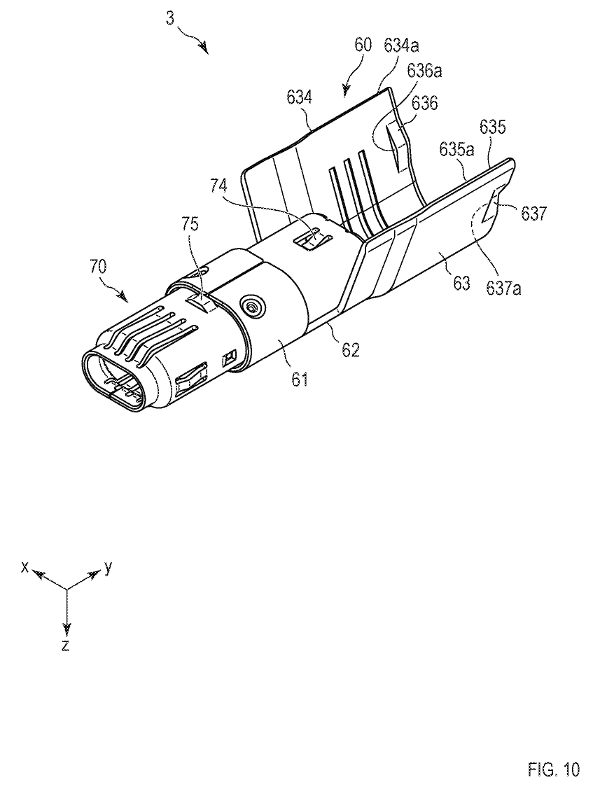

FIG. 10 is a diagram illustrating a state in which the rear end side of the second ground shell 70 is inserted from the accommodation portion 61 side of the first ground shell 60. A positioning protrusion portion 75 formed on the lower surface of the second ground shell 70 (surface on the -z direction side in FIG. 10) restricts movement of the first ground shell 60 toward the front side relative to the positioning protrusion portion 75. In this example, the rear end portion of the second ground shell 70 is inserted up to a region surrounded by the third crimp portion 633.

### Method for Assembling Shield Module

The shield module 2 is assembled, for example, through a process including the following steps S1 to S6. The description below will be provided on the assumption that the wire 10 with the sleeve portion 20 included, the holder 30, the signal contacts 40, the first housing 50, the first ground shell 60, and the second ground shell 70 have been prepared.

First, the pair of core wires 11 of the wire 10 are inserted into the pair of accommodation portions 31 of the holder 30 from the rear, one by one (step S1).

Then, the respective core wires 11 of the wire 10 with the holder 30 attached are inserted into the clamping portions 43, provided in a pair, of the signal contacts 40 from the rear, and the end portions 431 and 432 of each of the clamping portions 43 are swaged to fix the signal contacts 40 to the wire 10 (step S2).

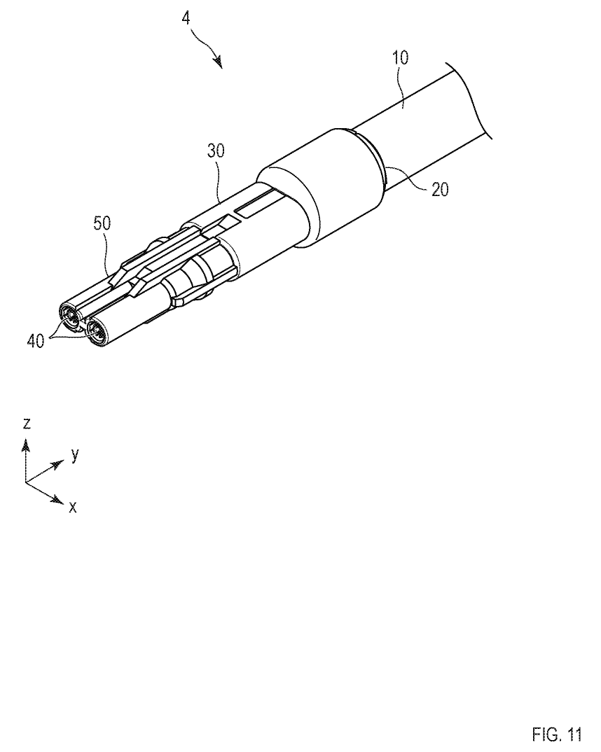

Subsequently, the pair of signal contacts 40 with the wire 10 attached are inserted from the rear sides of the accommodation portions 51 included in the first housing 50 (step S3). FIG. 11 is a perspective view illustrating the second shield sub-module as viewed from above. The second shield sub-module 4 is assembled in step S3.

Next, the opening portion 72 of the second ground shell 70 is inserted from the opening portion of the accommodation portion 61 of the first ground shell 60 so as to fit the first ground shell 60 and the second ground shell 70 to each other (step S4). In step S4, the first shield sub-module 3 is assembled in which the first end portion 634 and the second end portion 635 are in an open state as illustrated in FIG. 10.

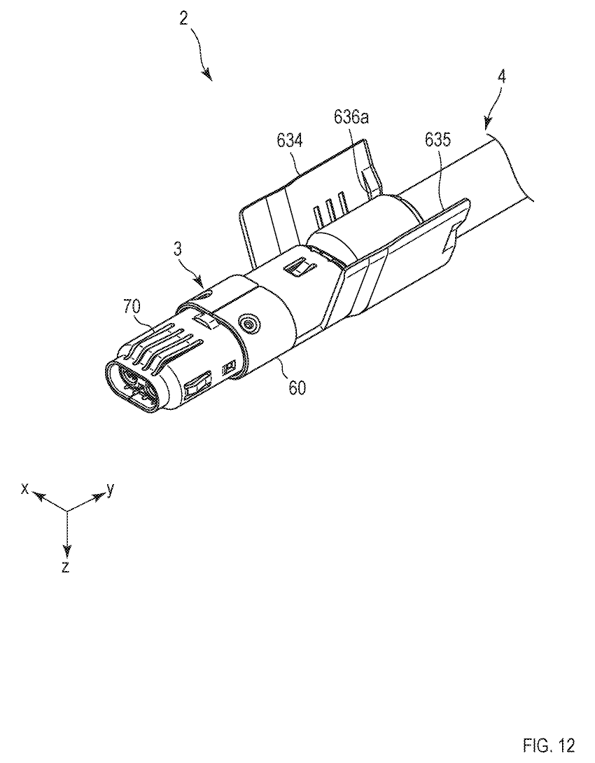

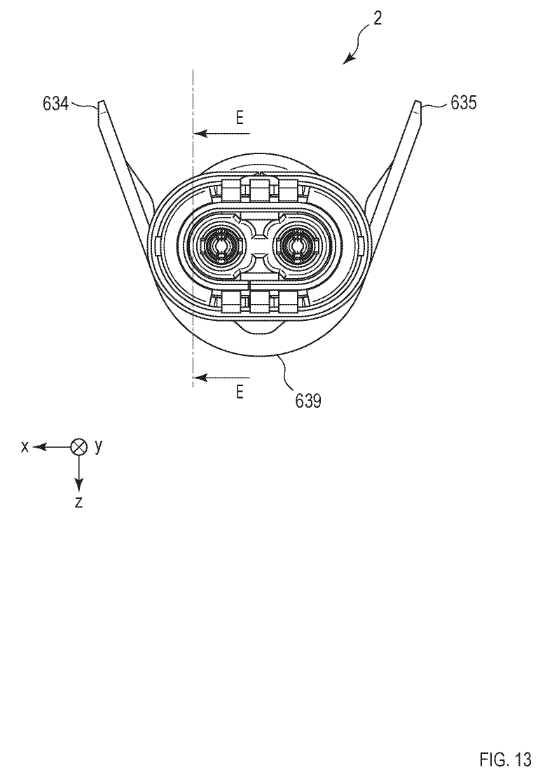

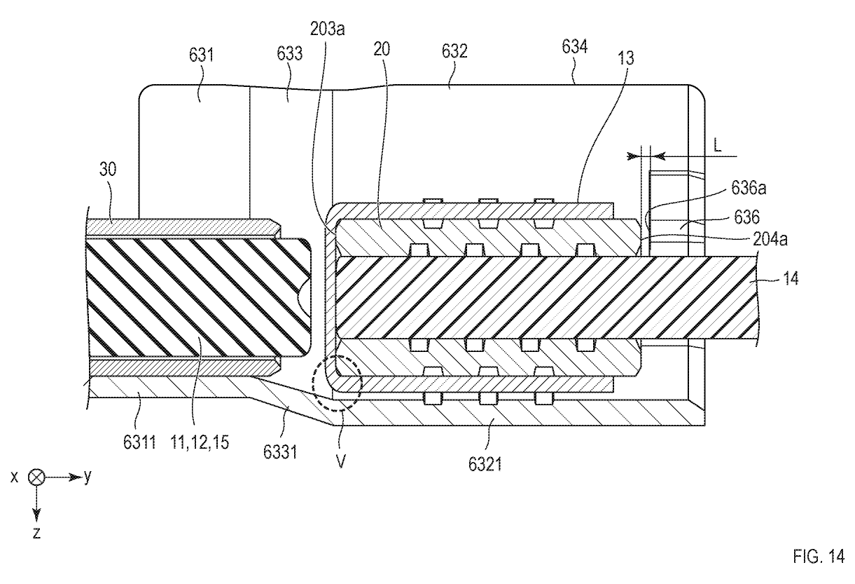

Then, the second shield sub-module 4 (FIG. 11) is inserted into the rear end side of the first ground shell 60 of the first shield sub-module 3 in which the first end portion 634 and the second end portion 635 are in the open state (step S5). FIG. 12 is a perspective view illustrating a state of the first ground shell in the shield module before swaging as viewed from below. FIG. 13 is a front view of FIG. 12. FIG. 14 is a diagram illustrating an enlarged portion of an E-E section in FIG. 13. A state illustrated in FIGS. 12-14 is obtained in step S5. The following state is obtained in step S5. The bottom portion of the first crimp portion 631, that is, the bottom portion 6311, which is a region positioned opposite to the open end portion (first end portion 634 and second end portion 635) side in the first crimp portion 631, covers a part of the outer periphery of the exposed insulation portions 12 with the second ground shell 70 and the holder 30 interposed therebetween (see also FIG. 6). The bottom portion 6321 of the second crimp portion 632, t6311hat is, the bottom portion 6321, which is a region positioned opposite to the open-end portion side in the second crimp portion 632, covers a part of the outer periphery of the shield portion 13. The bottom portion 6331 of the third crimp portion 633, that is, the bottom portion 6331, which is a region positioned opposite to the open-end portion side in the third crimp portion 633, covers a predetermined region (region V in FIG. 14) of the folded portion 131 of the shield portion 13.

Subsequently, the crimp portion 63 is swaged (step S6). Specifically, the third crimp portion 633 of the first ground shell 60 is abutted on the end portion of the sheath portion 14 on the end portion 111 side with the sleeve portion 20 and the shield portion 13 interposed therebetween, and at the same time, an end surface 634a of the first end portion 634 and an end surface 635a of the second end portion 635 are opposed to be abutted on each other and the crimp portion 63 is swaged in the circumferential direction, thereby engaging the projection portions 636 and 637 with the end portion on the rear side (opposite side of the end portion 111 side) of the sleeve portion 20. That is, the first end portion 634 and the second end portion 635 of the first ground shell 60 are swaged in a mutually abutted manner so as to engage the projection portions 636 and 637 with the end surface 204a of the sleeve portion 20. Consequently, the assembly of the shield module 2 is completed. In the present disclosure, "swaging in a mutually abutted manner" includes not only the case where actual abutting is performed for swaging, but also the case where opposing parts are not actually abutted on each other but are mutually brought to very close positions for swaging.

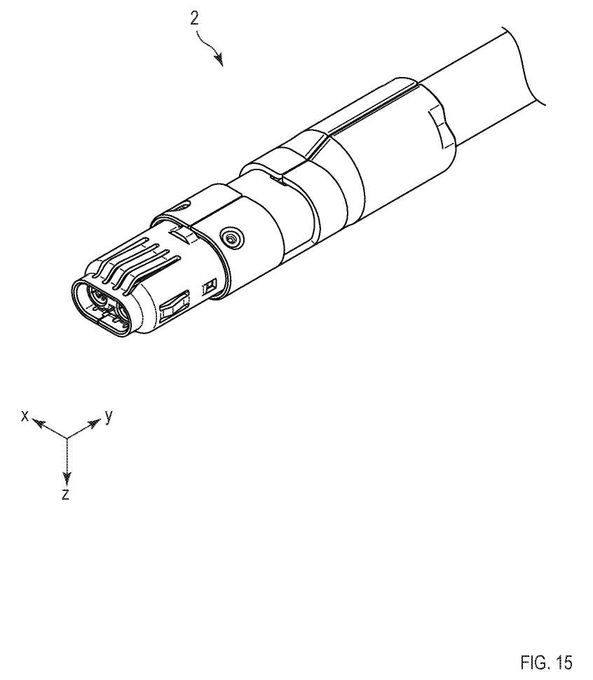

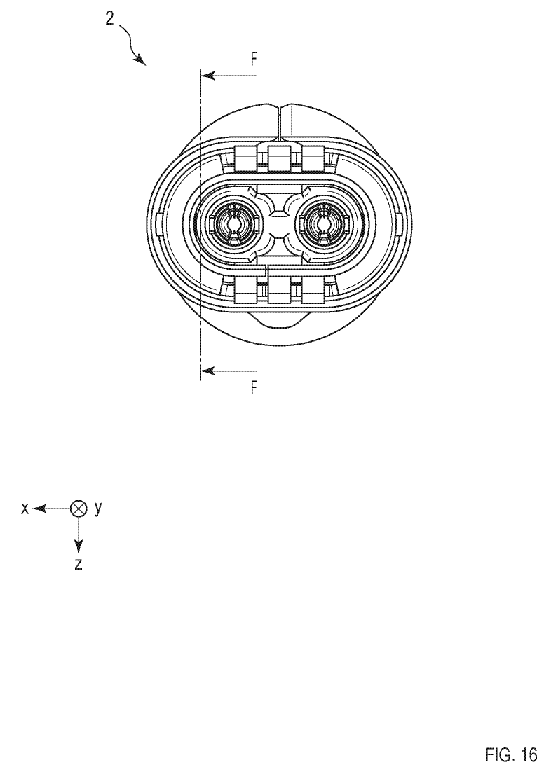

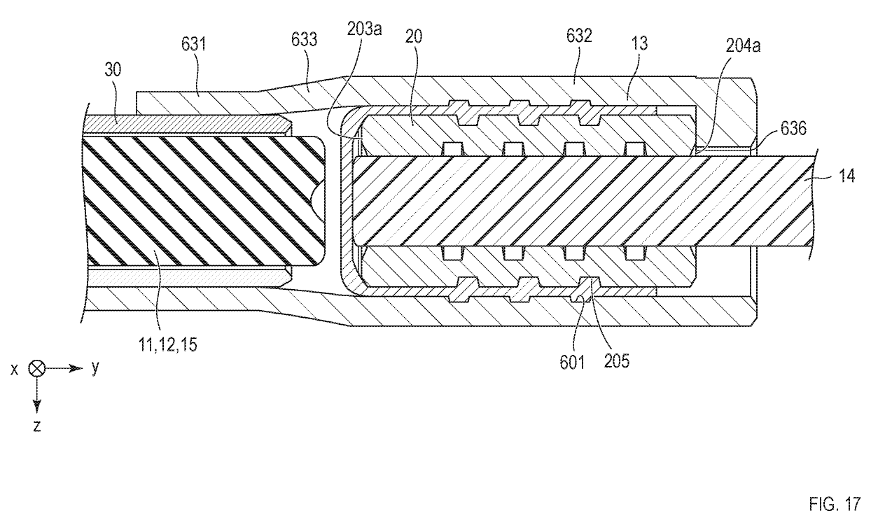

FIG. 15 is a perspective view illustrating a state of the first ground shell in the shield module after swaging as viewed from below. FIG. 16 is a front view of FIG. 15. FIG. 17 is a diagram illustrating an enlarged portion of an F-F section in FIG. 16. The F-F line corresponds to a position of the E-E line in FIG. 13. The shield module 2 illustrated in FIGS. 15-17 is assembled by swaging the second shield sub-module 4 (FIG. 12) in a manner to abut the end surface 634a of the first end portion 634 of the first ground shell 60 and the end surface 635a of the second end portion 635 on each other. After assembling the shield module 2, as described above, the shield module 2 is inserted into the second housing 80, and the CPA 81 and the retainer 82 are assembled to complete the shield connector 1.

The shield connector 1 according to the present embodiment has been described above. In the shield module 2 of the present embodiment, before the crimp portion 63 is swaged, the end surface 204a of the end portion 204 positioned on the rear side (+y direction side) in the short-hand direction of the sleeve portion 20 and an end surface 636a on the front side of the projection portion 636 are separated by a distance L in the longitudinal direction (y-axis direction) of the shield module 2, as illustrated in FIG. 14. Although not visible in FIG. 14, the end surface 204a and an end surface 637a on the front side of the projection portion 637 are separated by a predetermined distance in the longitudinal direction (y-axis direction) of the shield module 2.

By swaging the crimp portion 63, the third crimp portion 633 of the crimp portion 63 is abutted on the shield portion 13, causing the shield portion 13 and the sleeve portion 20 to move rearward (+y direction). That is, the end surface 204a of the end portion 204 positioned on the rear side in the short-hand direction of the sleeve portion 20 is abutted on the projection portions 636 and 637, thereby restricting the movement of the sleeve portion 20 in the right direction (+y direction) as viewed in FIG. 17. In other words, when the third crimp portion 633 is abutted on a predetermined region in the shield portion 13 on one end side of the core wire 11 (end portion 111 side) and at the same time, the end surface 634a of the first end portion 634 and the end surface 635a of the second end portion 635 are opposed in a mutually abutted manner and the wire 10 is swaged in the circumferential direction, the projection portions 636 and 637 are locked by the end portion 204 on the opposite side of one end side of the core wire 11 (end portion 111 side) in the sleeve portion 20. The sleeve portion 20 is abutted on the third crimp portion 633 on the end portion 203 side with the shield portion 13 interposed therebetween, and the end surface 204a on the end portion 204 side is abutted on the projection portions 636 and 637. That is, the position of the sleeve portion 20 in the shield module 2 is determined by swaging the crimp portion 63. This suppresses variations in a relative positional relationship between the wire 10 which is the core of the internal terminal and the first and second ground shells 60 and 70 which serve as the external terminals. This suppresses variations in positions of the core wires 11, the signal contacts 40 into which the core wires 11 are inserted, the first housing 50 into which the signal contacts 40 are inserted, and the second ground shell 70 into which the first housing 50 is inserted. The shield module 2 according to the present disclosure can suppress variations in the position of the second shield sub-module 4 which is the internal terminal.

By swaging the crimp portion 63, the sleeve portion 20, which has reinforced the periphery of the core wires 11, is further swaged. This reduces the distance between the core wires 11 and the sleeve portion 20. Swaging the crimp portion 63 causes the core wires 11 and the surrounding sleeve portion 20 to come into close proximity, and therefore the crimp portion 63 is inherently a portion where impedance is likely to degrade. If the position of the sleeve portion 20 varies, the positional relationship between the core wires 11 and the sleeve portion 20 also varies. In this case, if the sleeve portion 20 is displaced to an unexpected position, the impedance will further degrade. The shield module 2 according to the present disclosure can restrict the movement of the sleeve portion 20 via the projection portions 636 and 637 so that the relative positional relationship between the core wires 11 and the sleeve portion 20 does not become greater than expected. This enables swaging by the crimp portion 63 while maintaining a balance in the relative positional relationship between the core wires 11 and the sleeve portion 20.

Here, consider a case where the sleeve portion 20 at the stage of assembling the wire 10 is crimped and swaged so strongly that the relative position with respect to the sheath portion 14 does not displaced. In this case, even if the sleeve portion 20 at the stage of being attached on the wire 10 is displaced from an originally intended position, the degradation of impedance as described above may still occur. In the shield module 2 of the present disclosure, the sleeve portion 20 before swaging the crimp portion 63 is not yet in a crimped state with respect to the sheath portion 14 and is movable with respect to the sheath portion 14. Accordingly, swaging the crimp portion 63 simultaneously further swages the sleeve portion 20. That is, the projection portions 636 and 637 control the position of the sleeve portion 20, thereby contributing to balancing the positional relationship between the core wires 11 and the sleeve portion 20. Therefore, the shield connector 1 of the present disclosure also contributes to preventing impedance degradation, which is particularly required for high-frequency shield connectors.

The embodiment of the present disclosure has been described above. In the present disclosure, the projection portions 636 and 637 are formed on the rear side, near the end portion 638, of the second crimp portion 632. However, taking into account the length of the second crimp portion 632 and the length of the sleeve portion 20, the projection portions 636 and 637 may be formed at positions other than the rear side of the second crimp portion 632. Further, in the present disclosure, two projection portions, namely the projection portions 636 and 637, are provided. However, the number of projection portions may be one or three or more. Additionally, the size of the projection portion may be also adjusted appropriately. In addition, it goes without saying that the above-described shield connector can be modified as appropriate without departing from the spirit and scope of the present disclosure.

The foregoing description of the embodiment of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A shield connector comprising:
a wire including a core wire; and
a first ground shell fixed at an end portion of the wire by swaging a first end portion and a second end portion in a mutually abutted manner, the first end portion and the second end portion being open end portions, wherein
the wire includes:
an insulation portion which covers an outer periphery of the core wire,
a sheath portion which covers an outer periphery of the insulation portion in a manner to expose one end portion of the insulation portion for a predetermined length,
a sleeve portion which is made of metal and covers an outer periphery of the sheath portion for a predetermined length in a longitudinal direction of the shield connector, and
a shield portion which includes a main body portion, the main body portion covering the outer periphery of the insulation portion from an inner periphery side of the sheath portion, and a folded portion, the folded portion covering an end surface on one end portion side of each of the sheath portion and the sleeve portion and covering an outer periphery of the sleeve portion for a predetermined length in the longitudinal direction of the shield connector, and
the first ground shell includes:
a first crimp portion which is a first region extending from a part of the first end portion to a part of the second end portion, and is to have a ring shape with a first circumferential diameter after the swaging and cover the outer periphery of the insulation portion which is exposed,
a second crimp portion which is a second region extending from another part of the first end portion to another part of the second end portion, and is to have a ring shape with a second circumferential diameter, the second circumferential diameter being longer than the first circumferential diameter, after the swaging and cover an outer periphery of the shield portion,
a third crimp portion which couples the first crimp portion and the second crimp portion to each other from the first end portion to the second end portion, and
a projection portion which engages with the end surface of the sleeve portion so as to restrict further movement of the sleeve portion, when the first end portion and the second end portion are swaged in a mutually abutted manner and when the third crimp portion is abutted on a predetermined region of the folded portion and a tip of the folded portion and the sleeve portion accordingly move in a direction away from the end surface of the sheath portion.

2. The shield connector according to claim 1, wherein the projection portion is formed in a vicinity of an end portion in a circumferential direction in the second crimp portion.

3. The shield connector according to claim 2, wherein the projection portion is composed of a first projection portion formed in a vicinity of the first end portion and a second projection portion formed in a vicinity of the second end portion.

4. A method for assembling a shield connector, being assembled with a wire including a core wire and a first ground shell having a first end portion and a second end portion which are open end portions, in which
the wire includes:
an insulation portion which covers an outer periphery of the core wire,
a sheath portion which covers an outer periphery of the insulation portion in a manner to expose one end portion of the insulation portion for a predetermined length,
a sleeve portion which is made of metal and covers an outer periphery of the sheath portion for a predetermined length in a longitudinal direction of the shield connector, and
a shield portion which includes a main body portion, the main body portion covering the outer periphery of the insulation portion from an inner periphery side of the sheath portion, and a folded portion, the folded portion covering an end surface on one end portion side of each of the sheath portion and the sleeve portion and covering an outer periphery of the sleeve portion for a predetermined length in the longitudinal direction of the shield connector, and
the first ground shell includes:
a first crimp portion which is a first region extending from a part of the first end portion to a part of the second end portion, and is to have a ring shape with a first circumferential diameter after swaging and cover the outer periphery of the insulation portion which is exposed,
a second crimp portion which is a second region extending from another part of the first end portion to another part of the second end portion, and is to have a ring shape with a second circumferential diameter, the second circumferential diameter being longer than the first circumferential diameter, after the swaging and cover an outer periphery of the shield portion,
a third crimp portion which couples the first crimp portion and the second crimp portion to each other from the first end portion to the second end portion, and
a projection portion which is formed on a position in the second crimp portion, the position being to be on an inner side of a ring shape after the swaging, the method for assembling a shield connector which is assembled by a process comprising:
preparing the wire and the first ground shell having the first end portion and the second end portion which are open end portions before the swaging;
covering a part of the outer periphery of the insulation portion, the insulation portion being exposed, by a bottom portion positioned on an opposite side to the open-end portions in the first crimp portion;
covering a part of the outer periphery of the shield portion by a bottom portion positioned on an opposite side to the open end portions in the second crimp portion;
covering a predetermined region of the folded portion of the shield portion by a bottom portion positioned on an opposite side to the open-end portions in the third crimp portion; and
swaging the first end portion and the second end portion of the first ground shell in a mutually abutted manner so as to engage the projection portion with an end surface on another end portion side of the sleeve portion.
